(19) United States
(12) Patent Application Publication
(10) Pub. No.: US 2009/0148084 A1
(43) Pub. Date: Jun. 11, 2009

(54) Fluid Dynamic Bearing Device

(76) Inventors: Isao Komori, Kuwana-shi (JP); Kenji Hibi, Kuwana-shi (JP); Yasuhiro Yamamoto, Kuwana-shi (JP)

Correspondence Address: WENDEROTH, LIND & PONACK, L.L.P., 1030 15th Street, N.W.,, Suite 400 East, Washington, DC, 20005-1503, US

(21) Appl. No.: 11/628,670

(22) PCT Filed: Jun. 2, 2006
(86) PCT No.: PCT/JP2006/311061

§ 371 Date: Sep. 11, 2008

(30) Foreign Application Priority Data
Jul. 14, 2005 (JP) 2005-205794

(51) Int. Cl. F16C 32/06

(52) U.S. Cl. 384/107

(57) ABSTRACT

A fluid dynamic bearing device equipped with a shaft member of high strength and capable of maintaining high bearing performance is provided at low cost. A shaft blank (23) has, as an integrated unit, a shaft part (23a) formed of a material of a higher strength than resin, and a protruding part (23b) protruding radially outwards from the shaft part (23a). A shaft member (2) is equipped with the shaft blank (23) and a resin portion (24) covering at least one end surface of the protruding part (23b) of the shaft blank (23) and facing a thrust bearing gap.

### BACKGROUND OF THE INVENTION

1. Field of the Invention

The present invention relates to a fluid dynamic bearing device.

2. Description of the Related Art

A fluid dynamic bearing device is a bearing device having a mechanism for supporting a shaft member in a non-contact fashion by a dynamic pressure action of a fluid (lubricating fluid) generated in a bearing gap. The fluid dynamic bearing device is endowed with various features, such as high speed rotation, high rotational accuracy, and low noise, and is suitable as a bearing for use in a spindle motor for a disk drive in an information apparatus, for example, a magnetic disk device, such as an HDD or an FDD, an optical disk device, such as a CD-ROM, a CD-R/RW, or a DVD-ROM/RAM, or a magneto-optical disk device, such as an MD or MO, a polygon scanner motor for a laser beam printer (LBP), or a small motor for a projector color wheel, an axial fan, or the like.

Examples of the fluid dynamic bearing devices include: a type in which the radial bearing portion is formed by a fluid dynamic bearing and in which the thrust bearing portion is formed by a pivot bearing or the like, with the bearing portions being supported in a contact fashion (so-called contact type; and a type in which both the radial bearing portion and the thrust bearing portion are formed by fluid dynamic bearings (so-called non-contact type); and the right type of dynamic pressure bearing is used properly according to the use and the requisite characteristics.

In a known example of a non-contact type fluid dynamic bearing device, a shaft member is formed of a shaft portion and a flange portion. For example, JP 2003-314537 A discloses a fluid dynamic bearing in which the shaft portion is formed of a metal material and in which the flange portion is formed of a resin material. JP 2001-41246 A discloses a fluid dynamic bearing in which both the shaft portion and the flange portion are formed of a metal material.

In the fluid dynamic bearing device disclosed in JP 2003-314537 A, the shaft member is formed by forming the flange portion by injection molding of a resin, using a metal shaft portion as an outsert component. However, in such outsert molding, strength of the connecting portion between the metal shaft portion and the resin flange portion is rather low. In particular, when an axial load is applied to the shaft member, there is a fear of shear fracture occurring at the connecting portion between the shaft portion and the flange portion.

In the fluid dynamic bearing device disclosed in JP 2001-41246 A, the shaft member is formed by forming the shaft portion and the flange portion separately of a metal material and fixing them to each other by welding. As compared with adhesion or press-fitting, welding is relatively advantageous in that it helps to enhance the strength with which the two portions are connected together. On the other hand, the strength of the shaft member depends upon the welding strength, so there is a fear of variation in strength being generated. Further, it involves an excessively high cost.

### SUMMARY OF THE INVENTION

It is an object of the present invention to provide at low cost a fluid dynamic bearing device equipped with a shaft member of high strength and capable of maintaining high bearing performance.

To achieve the above object, according to the present invention, there is provided a fluid dynamic bearing device including: a bearing member; a shaft member equipped with a shaft portion to be inserted into an inner periphery of the bearing member; a radial bearing portion supporting the shaft member in a radial direction by a dynamic pressure action of a fluid generated in a radial bearing gap; and a thrust bearing portion supporting the shaft member in a thrust direction by a dynamic pressure action of the fluid generated in a thrust bearing gap, characterized in that the shaft member is equipped with a shaft blank formed by integrating a shaft part constituting the shaft portion with a protruding part protruding radially outwards from the shaft part, and a resin portion covering at least one end surface of the protruding part and facing the thrust bearing gap.

In the above-described construction of the present invention, a flange portion facing a thrust bearing gap is formed by the protruding part of the shaft blank and the resin portion covering the same. The protruding part is formed integrally with the shaft part constituting the shaft portion, so it is possible to achieve a marked increase in the connecting strength for the shaft portion and the flange portion, making it possible to achieve an increase in terms of shear strength with respect to an axial load. Further, there no need to perform welding separately as in the prior art, so it is possible to reduce the number of steps and achieve a reduction in production cost. In addition, it is possible to prevent generation of variation in strength at the connecting portion.

The flange portion is formed, for example, by injecting resin material where it is needed, with the shaft blank being fixed in position in the mold (insert molding or outsert molding). The molding accuracy of the flange portion, for example, the flatness of the end surfaces of the flange portion and the perpendicularity between the flange portion and the shaft portion, depends upon the mold precision of the mold. Thus, as long as the requisite mold precision is secured, at least the precision of the protruding part of the shaft blank may be roughly determined without adversely affecting the molding accuracy of the resin portion. By achieving an improvement in terms of the flatness and perpendicularity of the flange portion through injection molding, it is possible to maintain highly accurate bearing performance in the thrust bearing portions formed between the end surfaces of the flange portion and the surfaces facing these end surfaces. Further, the flange portion is covered with resin, so it is possible to achieve an improvement in terms of the sliding characteristic in the thrust direction when starting/stopping the fluid dynamic bearing device, thus achieving an improvement in terms of wear resistance.

Not only the protruding part of the shaft blank but also the outer peripheral surface of the shaft part may be covered with the resin portion. With this construction, not only the precision of the protruding part but also that of the shaft part of the shaft blank may be roughly determined without adversely affecting the molding precision of the resin portion. Further, through injection molding, it is possible to maintain high bearing performance not only for the thrust bearing portion but also for the radial bearing portion. Further, it is possible to achieve an improvement in terms of the sliding characteristic in the radial direction when starting/stopping the bearing device, thereby making it possible to achieve a further improvement in terms of wear resistance.

It is desirable to form a dynamic pressure generating portion for generating fluid dynamic pressure in each bearing gap on one or both of a portion of the resin portion facing the thrust bearing gap and a portion of the resin portion facing the radial bearing gap. In this case, the dynamic pressure generating portion can be formed simultaneously with the injection molding of the resin. Thus, it is possible to omit the step of separately forming the dynamic pressure generating portion, thus making it possible to achieve a further reduction in the cost of a fluid dynamic bearing device.

When, after the injection molding, the resin portion solidifies, shrinkage of the resin occurs. The shrinkage varies according to the thickness of the resin portion, so, by making the thickness of the resin portion uneven in a fixed direction (e.g., circumferential direction), it is possible to control the shrinkage amount of the resin portion, making it possible to form the dynamic pressure generating portions of the radial bearing portion and the thrust bearing portion through a difference in the shrinkage amount (sink). For example, when injection molding is performed, with the outer peripheral surface of the shaft part of the shaft blank formed in a non-cylindrical configuration, and with the mold surface opposed thereto formed in a configuration differing therefrom (e.g., cylindrical configuration), the outer peripheral surface of the resin portion after the solidification thereof is of a non-cylindrical configuration, such as a multi-arc surface, due to a difference in shrinkage amount, and it is possible to utilize this as the dynamic pressure generating portion of the radial bearing portion. When the end surface of the protruding part of the shaft blank is formed as a surface with asperities due to the difference in the shrinkage amount, and the mold surface opposed thereto is formed as a flat surface without asperities due to the difference in the shrinkage amount, the end surface of the resin portion becomes likewise a surface with asperities, such as a stepped surface (or corrugated surface), so it is possible to utilize this as the dynamic pressure generating portion of the thrust bearing portion.

The fluid dynamic bearing device, constructed as described above, can be suitably used in a motor having a rotor magnet and a stator coil, for example, a spindle motor for a disk device, such as an HDD.

As is apparent from the above, according to the present invention, it is possible to provide at low cost a fluid dynamic bearing device equipped with a shaft member of high strength and capable of maintaining high bearing performance.

### BRIEF DESCRIPTION OF THE DRAWINGS

In the accompanying drawings:

FIG. 1A is a sectional view of a shaft member;

FIG. 1B is a plan view of a lower end surface of the shaft member;

FIG. 2 is a sectional view of an example of a spindle motor in which a fluid dynamic bearing device is incorporated;

FIG. 3 is a sectional view of a fluid dynamic bearing device having a construction according to the present invention;

FIG. 4 is a sectional view of another form of the fluid dynamic bearing device;

FIG. 5 is a sectional view of another form of the fluid dynamic bearing device;

FIG. 6 is a sectional view of another form of the fluid dynamic bearing device;

FIG. 7 is a sectional view of another form of a radial bearing portion;

FIG. 8 is a sectional view of another form of the radial bearing portion;

FIG. 9 is a sectional view of another form of the radial bearing portion;

FIG. 10A is a sectional view of a shaft portion when a shaft member is formed by injection molding;

FIG. 10B is a sectional view of the shaft portion after solidification of a resin portion; and

FIG. 11 is a sectional view of another form of the shaft portion after the solidification of the resin portion.

### DESCRIPTION OF THE PREFERRED EMBODIMENTS

In the following, embodiments of the present invention will be described with reference to the drawings.

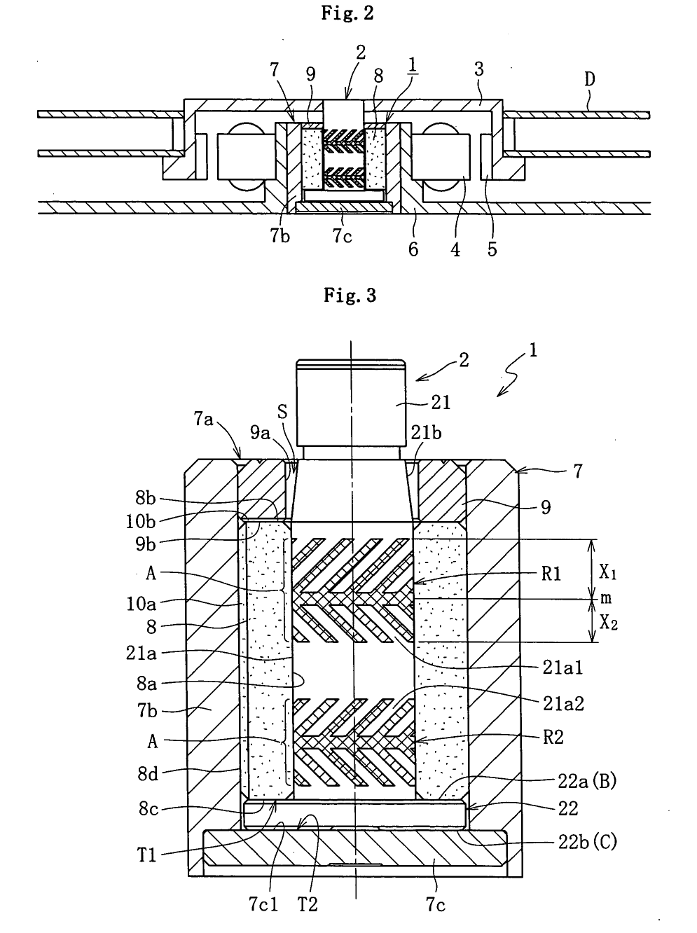

FIG. 2 shows a construction example of a spindle motor for an information apparatus in which a fluid dynamic bearing device 1 according to the present invention is incorporated. This spindle motor is used in a disk drive apparatus, such as an HDD, and is equipped with the fluid dynamic bearing device 1, a disk hub 3 mounted to a shaft member 2 of the fluid dynamic bearing device 1, a stator coil 4 and a rotor magnet 5 opposed to each other through the intermediation, for example, of a radial gap, and a bracket 6. The stator coil 4 is mounted to an outer periphery of the bracket 6, and the rotor magnet 5 is mounted to an inner periphery of he disk hub 3. The disk hub 3 retains in its outer periphery one or a plurality of disks D, such as magnetic disks. Further, a housing 7 of the fluid dynamic bearing device 1 is mounted to the inner periphery of the bracket 6, whereby the fluid dynamic bearing device 1 is fixed to the bracket 6. When electricity is supplied to the stator coil 4, an electromagnetic force generated between the stator coil 4 and the rotor magnet 5 causes the rotor magnet 5 to rotate, and, with that, the disk hub 3 and the shaft member 2 rotate integrally.

FIG. 3 is an enlarged sectional view showing an example of the fluid dynamic bearing device 1 to be used in the above spindle motor. The fluid dynamic bearing device 1 is mainly composed of a housing 7 having an opening 7a at one end thereof, a cylindrical sleeve 8 fixed to the inner periphery of the housing 7, a shaft member 2 formed of a shaft portion 21 and a flange portion 22, and a seal member 9 fixed to the opening 7a of the housing 7. In this embodiment, the housing 7 and the bearing sleeve 8 constitute bearing members. In the following, for the sake of convenience in illustration, the side sealed by the seal member 9 will be referred to the upper side, and the side axially opposite thereto will be referred to as the lower side.

The housing 7 is formed of a metal material, such as stainless steel or brass, or a resin material, and has, as separate structures, a cylindrical side portion 7b and a bottom portion 7c closing the opening at the lower end of the side portion 7b. In this embodiment, the upper end surface 7c1 of the bottom portion 7c is formed as a flat and smooth surface having no dynamic pressure groove, etc. It is also possible to form the side portion 7b and the bottom portion 7c of the housing 7 integrally of a metal material or a resin material.

The bearing sleeve 8 is formed in a cylindrical configuration and is fixed to the inner peripheral surface of the housing 7. The bearing sleeve 8 is formed of a porous material made, for example, of a sintered metal, in particular, a sintered metal whose main component is copper, or a soft metal, such as brass. In this embodiment, the inner peripheral surface 8a of the bearing sleeve 8 is formed as a smooth cylindrical surface having no dynamic pressure groove, etc. The lower end surface 8c of the bearing sleeve 8 is also formed as a smooth and flat surface having no dynamic pressure grooves, etc.

The seal member 9, which is formed of a metal material or a resin material, is fixed to the opening 7a at the upper end of the housing 7 by press-fitting, adhesion, etc. In this embodiment, the seal member 9 has an annular configuration, and is formed as a member separate from the housing 7. The inner peripheral surface 9a of the seal member 9 is opposed to a tapered surface 21b of the shaft portion 21 through the intermediation of a seal space S of a predetermined volume. The tapered surface 21b of the shaft portion 21 is gradually reduced in diameter as it extends upwards, and also functions as a centrifugal seal as the shaft member 2 rotates. The inner space of the fluid dynamic bearing device 1, which is sealed by the seal member 9, is filled with a lubricating oil serving as the fluid. In this state, the oil level of the lubricating oil is maintained within the range of the seal space S. It is also possible to integrally form the seal member 9 and the housing 7 to thereby achieve a reduction in the number of components and a reduction in assembly man-hours.

The shaft member 2 has a double structure composed of a shaft blank 23 formed of a metal, such as stainless steel, and a resin portion 24 covering the shaft blank 23. The metal shaft blank 23 has an integral structure composed of a shaft part 23a and a protruding part 23b protruding radially outwards from the shaft part 23a, and is shaped, for example, by forging. To provide a detent between the shaft part 23a and the resin portion 24, it is desirable to form circumferential asperities by knurling on the outer peripheral surface of the shaft part 23a and the outer peripheral surface of the protruding part 23b, or to impart a non-circular sectional configuration to these outer peripheral surfaces. The resin portion 24 is formed by injection molding, using the shaft blank 23 as an insert component (or an outsert component), and is composed of a portion covering the outer peripheral surface and the end surfaces of the protruding part 23b, and a portion covering the outer peripheral surface of the shaft part 23a. It suffices for the resin portion 24 to cover at least regions constituting a radial bearing surface A and thrust bearing surfaces B and C described below. It is also possible for the resin portion 24 to cover other regions as needed (e.g., the entire surface of the shaft part 23a including the upper end surface of the shaft part 23a). With the above construction, the shaft portion 21 of the shaft member 2 is formed by the shaft part 23a of the shaft blank 23 and the resin portion 24 covering the same, and the disc-shaped flange portion 22 is formed by the protruding part 23b of the shaft blank 23 and the resin portion 24 covering the same.

While in the above-described example the metal shaft blank 23 is shaped by forging, there are no particular limitations regarding the method of forming the shaft blank 23 as long as the shaft blank 23 is formed as an integral unit and the requisite strength can be obtained. For example, it is also possible to form the shaft blank 23 by, for example, metal powder injection molding using metal powder and binder (so-called MIM molding), or injection molding of a low melting point metal. Further, as long as the requisite strength can be secured, the shaft blank 23 may also be formed of a material other than metal, for example, ceramics. A ceramics shaft blank 23 can be formed, for example, by injection molding using ceramics powder and binder (so-called CIM molding). Apart from this, it is possible to form the shaft blank 23 of a sintered metal or sintered ceramics.

There are no limitations regarding the resin material forming the resin portion 24 as long as it is a thermoplastic resin allowing injection molding, and both amorphous and crystalline resins can be used. Examples of the amorphous resin that can be used include polysulfone (PSU), polyethersulfone (PES), and polyphenylsulfone (PPSU). Examples of the crystalline resin that can be used include liquid crystal polymer (LCP), polyphenylene sulfide (PPS), and polyetheretherketone (PEEK). To impart various characteristics, such as mechanical strength and conductivity, to such resin material, it is possible to mix a filler, such as glass fibers, carbon fibers, or a conductive material, with the resin material as appropriate. It is possible to mix not only one but two or more kinds of filler.

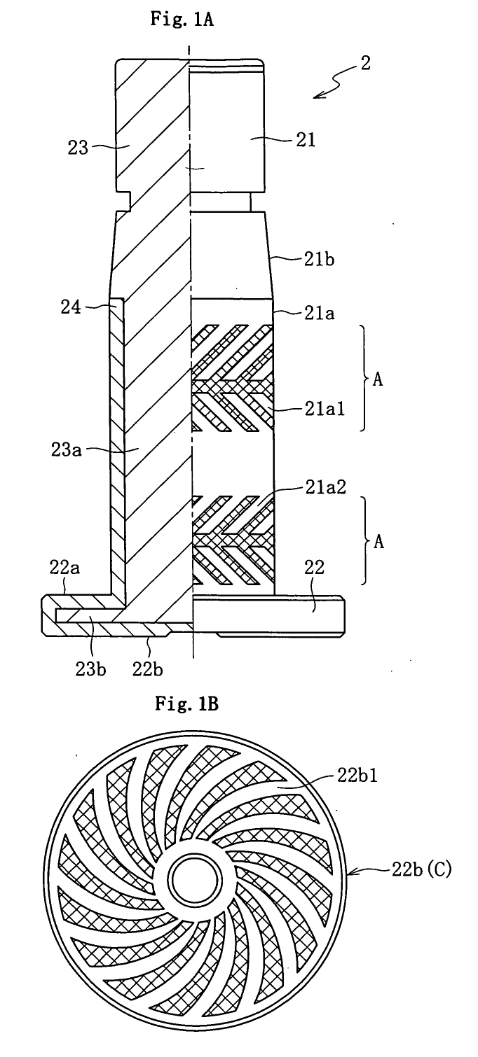

As shown in FIG. 1B, a plurality of dynamic pressure grooves 22b1 arranged, for example, in a spiral fashion, are formed as dynamic pressure generating portions in the upper end surface 22a and the lower end surface 22b of the flange portion 22 (resin portion 24) (FIG. 1B shows the dynamic pressure grooves 22b1 formed in the lower end surface 22b). An annular region of the upper end surface 22a having dynamic pressure grooves constitutes the thrust bearing surface B of a first thrust bearing portion T1, and an annular region of the lower end surface 22b having dynamic pressure grooves constitutes the thrust bearing surface C of a second thrust bearing portion T2. All the dynamic pressure generating portions (dynamic pressure grooves) formed in the upper end surface 22a and the lower end surface 22b can be formed simultaneously with the insert molding of the flange portion 22, so there is no need to take the trouble to separately form the dynamic pressure grooves, thereby making it possible to achieve a reduction in production cost. Apart from the spiral configuration, the dynamic pressure grooves may be of an arbitrary configuration, such as a herring bone-like configuration or a radial configuration.

As shown in FIG. 3 or 1A, two axially separated upper and lower regions constituting radial bearing surfaces A of a first radial bearing portion R1 and a second radial bearing portion R2, are formed on the outer peripheral surface 21a of the shaft portion 21 (resin portion 24). In these two regions, there are formed, as dynamic pressure generating portions, dynamic pressure grooves 21a1 and 21a2, which are arranged, for example, in a herringbone-like configuration. Like the above-mentioned thrust bearing surfaces, the dynamic pressure grooves 21a1 and 21a2 are also formed by molding at the time of insert molding. The upper dynamic pressure grooves 21a1 are formed asymmetrically with respect to an axial center m (axial center of the region between the upper and lower inclined grooves), with an axial dimension X1 of the region on the upper side of the axial center m being larger than the axial dimension X2 of the region on the lower side thereof. Thus, during rotation of the shaft member 2, the lubricating oil drawing force (pumping force) due to the upper dynamic pressure grooves 21a1 is larger than that due to the lower, symmetrical dynamic pressure grooves 21a2.

The shaft portion 21 of the shaft member 2 is inserted into the inner periphery of the bearing member 8, and the flange portion 22 is accommodated between the lower end surface 8c of the bearing member 8 and the upper end surface 7c1 of the bottom portion 7c. In the fluid dynamic bearing device 1, constructed as described above, when the shaft member 2 rotates, the radial bearing surfaces A of the outer peripheral surface 21a of the shaft portion 21 are opposed to the inner peripheral surface 8a of the bearing member 8 through the intermediation of the radial bearing gap. As the shaft member 2 rotates, there is generated a dynamic pressure action due to the lubricating oil filling the radial bearing gap, and, due to the pressure thereof, there are formed the first radial bearing portion R1 and the second radial bearing portion R2 rotatably supporting the shaft member 2 radially in a non-contact fashion.

Further, when the shaft member 2 rotates, the thrust bearing surface B formed on the upper end surface 22a of the flange portion 22 of the shaft member 2 is opposed to the lower end surface 8c of the bearing sleeve 8 through the intermediation of the thrust bearing gap. As the shaft member 2 rotates, the lubricating oil filling the thrust bearing gap generates a dynamic pressure action, and, due to the pressure thereof, there is formed the first thrust bearing portion T1 rotatably supporting the shaft member 2 in the thrust direction in a non-contact fashion. Similarly, when the shaft member 2 rotates, the thrust bearing surface C formed on the lower end surface 22b of the flange portion 22 of the shaft member 2 is opposed to the upper end surface 7c1 of the bottom portion 7c of the housing 7 through the intermediation of the thrust bearing gap. As the shaft member 2 rotates, the lubricating oil filling the thrust bearing gap generates a dynamic pressure action, and due to the pressure thereof, there is formed the second thrust bearing portion T2 rotatably supporting the shaft member 2 in the thrust direction in a non-contact fashion.

During the rotation of the shaft member 2, the lubricating oil is forced in toward the bottom portion 7c, so, if left as it is, the difference in pressure between the thrust bearing gaps of the thrust bearing portions T1 and T2 becomes extremely large, and there is a fear of generation of bubbles in the lubricating oil, leakage of the lubricating oil, or generation of vibrations attributable to this extremely large difference in pressure. However, as shown, for example, in FIG. 3, by providing in the outer peripheral surface 8d of the bearing sleeve 8 and the lower end surface 9b of the seal member 9, circulation paths 10a and 10b establishing communication between the thrust bearing gaps (in particular, the thrust bearing gap of the first thrust bearing portion T1) and the seal space S, the lubricating oil flows between the thrust bearing gap and the seal space S through the circulation paths 10a and 10b, so such difference in pressure is eliminated at the early stage, making it possible to avoid the above-mentioned problems. While FIG. 3 shows, by way of example, a case in which the circulation path 10a is formed in the outer peripheral surface 8d of the bearing sleeve 8 and in which the circulation path lob is formed in the lower end surface 9b of the seal member 9, it is also possible to form the circulation path 10a in the inner peripheral surface of the housing 7 and to form the circulation path 10b in the upper end surface 8b of the bearing sleeve 8.

As described above, in the present invention, in the shaft member 2, the shaft part 23a and the protruding part 23b of the shaft blank 23 respectively function as a core of the shaft portion 21 and a core of the flange portion 22, so, despite the fact that their surface is covered with a resin, it is possible to secure high rigidity for the shaft portion 21 and the flange portion 22. Further, the shaft part 23a and the protruding part 23b of the shaft blank 23 formed integrally, so it is possible to markedly enhance the connection strength of the shaft portion 21 and the flange portion 22, making it possible to achieve an improvement in shear strength with respect to the axial load. Further, there is no need to perform a connecting operation by welding, etc., so it is possible to achieve a reduction in processing cost. In addition, it is possible to suppress variation in strength depending upon the welding accuracy.

Various categories of precision are required of the shaft member 2, including the perpendicularity between the shaft portion 21 and the flange portion 22, and the flatness and parallelism of the flange portion 22 and the two end surfaces 22a and 22b. In the present invention, the above various categories of precision required of the shaft member 2 can be secured by enhancing the mold precision when forming the resin portion 24, so the various categories of precision of the shaft blank 23 itself may be roughly determined insofar as they do not adversely affect the molding precision of the resin portion 24. Thus, it is possible to omit an elaborate finishing process, thereby achieving a reduction in the production cost of the shaft blank 23.

Further, with the above construction, the outer peripheral surface 21a of the shaft portion 21 facing the radial bearing gap and the two end surfaces 22a and 22b of the flange portion 22 facing the thrust bearing gaps are formed of resin material, so even when, in particular, they come into contact with the opposing members (bearing member 8 and housing bottom portion 7c) at the time of starting/stopping the fluid dynamic bearing device 1, it is possible to improve the sliding property of the shaft member 2 and to prevent a reduction in rotational performance due to mutual wear.

When the resin portion 24 has an excessively large thickness, the influence of the sink generated as a result of the solidification and shrinkage thereof increases, making it difficult to secure the requisite precision regarding the cylindricity of the outer peripheral surface of the shaft portion 21 and the flatness, parallelism of the two end surfaces of the flange portion 22. On the other hand, when the thickness of the resin portion 24 is excessively small, the fluidity of the resin in the mold at the time of injection molding is reduced, and there is a fear of the molding precision being adversely affected. Further, when the precision of the shaft blank 23 is roughly determined, it may be rather difficult to secure the requisite molding precision for the resin portion 24 even if the mold precision is enhanced. For the above reasons, the thickness of the resin portion 24 is set within a range of 0.1 mm to 2.0 mm, more preferably, within a range of 0.2 mm to 1.0 mm.

While in the above-described case the outer peripheral surface of the shaft portion 21 and the two end surfaces 22b1 and 22b2 of the flange portion 22 are all covered with the resin portion 24, it is also possible not to cover the outer peripheral surface of the shaft portion 21 and one end surface of the flange portion with the resin portion 24 but to expose the surface of the shaft blank 23, forming the radial bearing surface A and the thrust bearing surface (B or C) with the dynamic pressure forming portions directly on the exposed surfaces. In this case, the bearing surfaces formed on the surface of the shaft blank 23 may be formed by plastic working, such as rolling or forging. Further, while in the above-described case the radial bearing surfaces A and the thrust bearing surfaces B and C are formed on the outer peripheral surface of the shaft portion 21 and the two end surfaces 22b1 and 22b2, it is also possible for those bearing surfaces A through C to be formed on the surfaces opposed to the outer peripheral surface of the shaft portion 21 and the two end surfaces 22b1 and 22b2 of the flange portion 22, more specifically, on the inner peripheral surface 8a of the bearing sleeve 8, the lower end surface 8c of the bearing sleeve 8, and the upper end surface 7c1 of the bottom portion 7c. In this case, the surfaces of the resin portion 24 opposed to those bearing surfaces A through C are all flat and smooth surfaces without any dynamic pressure generating grooves.

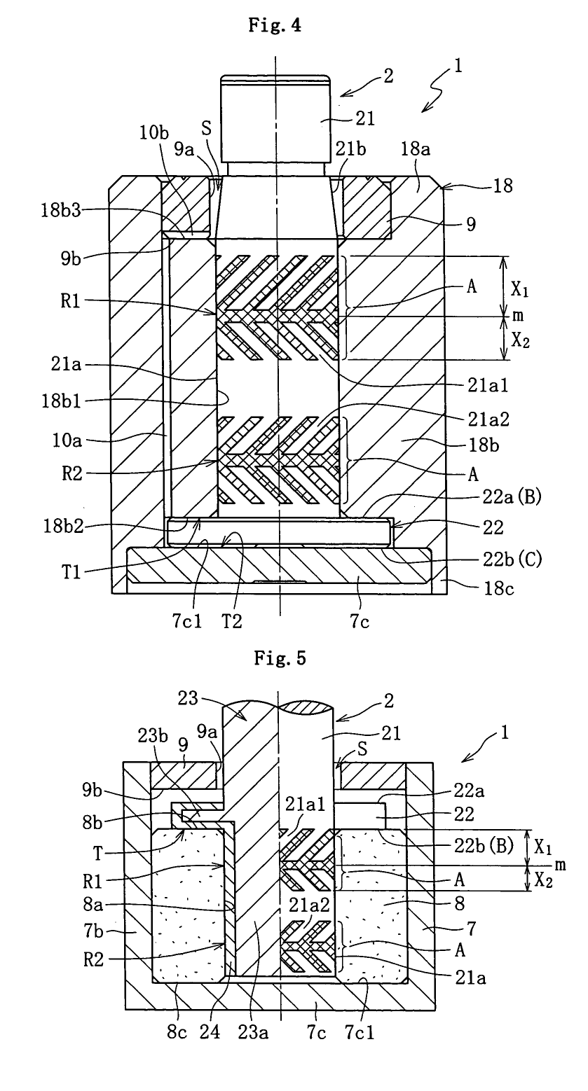

The present invention is not restricted to the above-described embodiment but can also be suitably applied to fluid dynamic bearing devices as shown in FIGS. 4 through 6. In the following, the same components and elements as those of the embodiment shown in FIGS. 1 and 3 are indicated by the same reference symbols, and a redundant description thereof will be omitted.

FIG. 4 shows a fluid dynamic bearing device 1 according to another embodiment of the present invention. In this embodiment, the housing 7 (side portion 7b) and the bearing sleeve 8, which are separate components shown in FIG. 3, are formed by an integral bearing member 18. The bearing member 18 is composed of a sleeve portion 18b into the inner periphery of which the shaft portion 21 can be inserted, a seal fixing portion 18a extending axially upwards from the outer side of the sleeve portion 18b and allowing fixation of the seal member 9 to the inner periphery thereof, and a bottom fixing portion 18c extending axially downwards from the outer side of the sleeve portion 18b and allowing fixation of a bottom portion 7c to the inner periphery thereof. In this embodiment, it is possible to achieve a reduction in the number of components and a reduction in assembly man-hours, so it is possible to achieve a further reduction in the production cost of the fluid dynamic bearing device 1.

FIG. 5 shows a fluid dynamic bearing device 1 according to another embodiment. In the fluid dynamic bearing device 1 of this embodiment, the thrust bearing portion T is situated on the opening side of the housing 7, and supports the shaft member 2 in one thrust direction so as to be out of contact with the bearing sleeve 8. The flange portion 22 is provided above the lower end of the shaft member 2, and the thrust bearing portion T is formed between the lower end surface 22b of the flange portion 22 and the upper end surface 8b of the bearing sleeve 8. The seal member 9 is attached to the inner periphery of the opening of the housing 7, and the seal spaces is formed between the inner peripheral surface 9a of the seal member 9 and the outer peripheral surface 21a of the shaft portion 21 of the shaft member 2. The lower end surface 9b of the seal member 9 is opposed to the upper end surface 22a of the flange portion 22 through the intermediation of an axial gap. When the shaft member 2 is upwardly displaced, the upper end surface 22a of the flange portion 22 is engaged with the lower end surface 9b of the seal member 9, whereby detachment of the shaft member 2 is prevented.

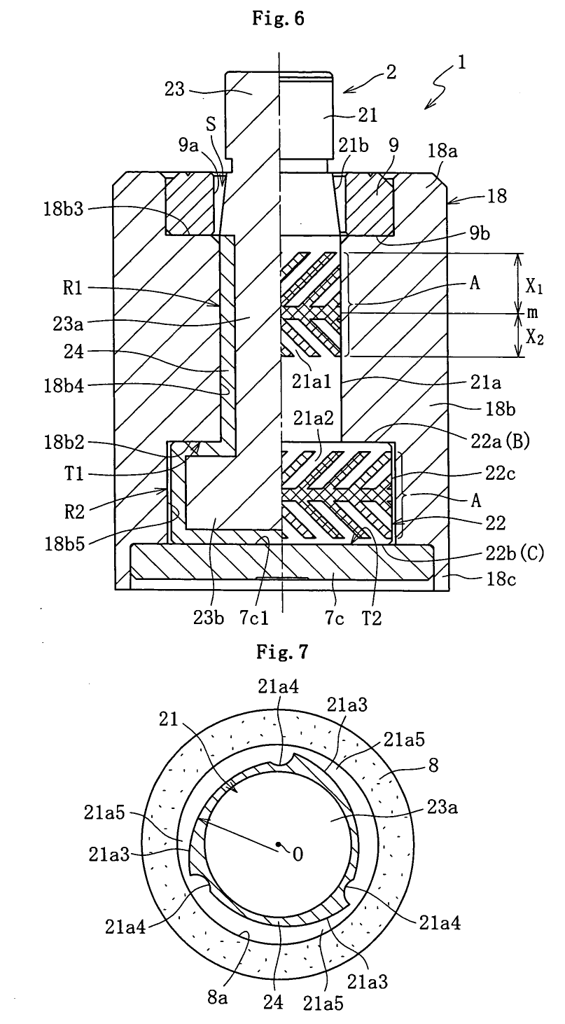

FIG. 6 shows a fluid dynamic bearing device 1 according to another embodiment. In contrast to the embodiments shown in FIGS. 3 and 4, in this embodiment, the axial width of the flange portion 22 of the shaft member 2 is enlarged, and dynamic pressure grooves 21a2 as the dynamic pressure generating portions are formed in an outer peripheral surface 22c of the flange portion 22 (i.e., the resin portion 24 forming the same). The first radial bearing portion R1 is formed between the outer peripheral surface 21a of the shaft portion 21 and the small-diameter inner peripheral surface 18b4 of the bearing member 18 opposed thereto, and the second radial bearing portion R2 is formed between the outer peripheral surface 22c of the flange portion 22 and the large-diameter inner peripheral surface 18b5 of the bearing member 18 opposed thereto. In this embodiment, the axial distance between the first thrust bearing portion T1 and the second thrust bearing portion T2 is increased. Further, the second radial bearing portion R2 is formed on the outer side as compared with the embodiments shown in FIGS. 3 and 4, so it is possible to enhance the radial bearing rigidity and the thrust bearing rigidity, making it possible to achieve an improvement in terms of proof stress with respect to moment load.

While in the above-described embodiments herringbone-shaped or spiral-shaped dynamic pressure grooves are adopted as the dynamic pressure generating portions formed in the radial bearing surfaces of the radial bearing portions R1 and R2, it is also possible for the radial bearing portions R1 and R2 to be formed by so-called multi-arc bearings, stepped bearings or non-cylindrical bearings. In those bearings, undulated surfaces, such as multi-arc surfaces, stepped surfaces, or harmonic-waveform surfaces, are formed as the dynamic pressure generating portions.

FIG. 7 shows an example of the case in which one or both of the radial bearing portions R1 and R2 are formed by multi-arc bearings. In the figure, the region of the outer peripheral surface of the shaft portion 21 (resin portion 24) constituting the radial bearing surface is formed by a plurality of (three, in the case shown) arcuate surfaces 21a3. The arcuate surfaces 21a3 are eccentric arcuate surfaces whose centers are offset from a rotation center O by the same distance, and are formed at equal circumferential intervals. Axial separation grooves 21a4 are formed between the eccentric arcuate surfaces 21a3.

By inserting the shaft portion 21 constructed as described above into the bore defined by the inner peripheral surface 8a of the bearing sleeve 8, the radial bearing gaps of the radial bearing portions R1 and R2 are formed between the eccentric arcuate surfaces 21a3 and the separation grooves 21a4 in the outer periphery of the shaft portion 21 and the inner peripheral surface 8a of the bearing sleeve 8. Of the radial bearing gaps, the regions formed by the eccentric arcuate surfaces 21a3 and the inner peripheral surface 8a constitute wedge-like gaps 21a5 whose gap width is gradually diminished in one circumferential direction. The diminishing direction of the wedge-like gaps 21a5 coincides with the rotating direction of the shaft portion 21. A multi-arc bearing thus constructed is sometimes referred to as a tapered bearing.

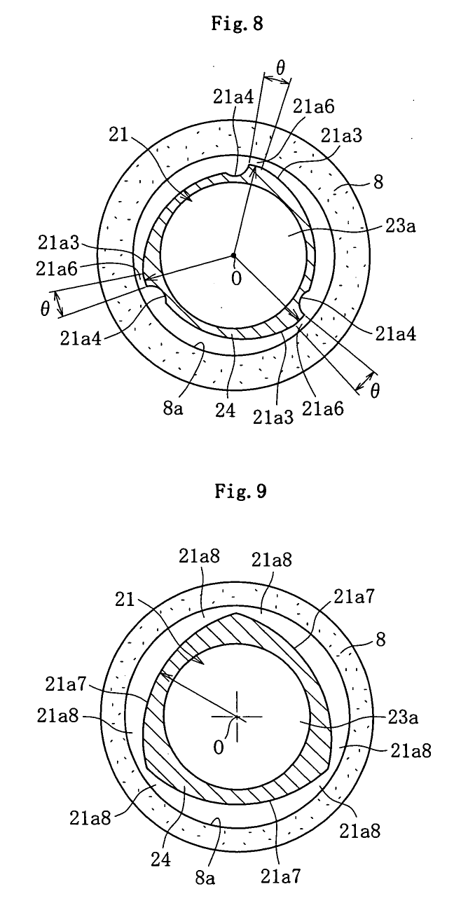

FIG. 8 shows another example of the case in which one or both of the radial bearing portions R1 and R2 are formed by multi-arc bearings. In this example, the construction of FIG. 7 is modified such that predetermined minimum-gap side regions θ of the arcuate surf aces 21a3 are formed by concentric arcs whose center of curvature coincides with the rotation center O. Thus, in the predetermined regions θ, the radial bearing gaps (minimum gap) 21a6 are fixed. A multi-arc bearing thus constructed is sometimes referred to as a tapered flat bearing.

FIG. 9 shows another example of the case in which one or both of the radial bearing portions R1 and R2 are formed by multi-arc bearings. In this example, the region of the outer peripheral surface of the shaft portion 21 (resin portion 24) constituting the radial bearing surface is formed by a plurality of (three, in the case shown) arcuate surfaces 21a7. The centers of the arcuate surfaces are offset from the rotation center O. In the regions defined by the arcuate surfaces 21a7, the radial bearing gaps 21a8 have a wedge-like configuration gradually diminished in both circumferential directions. Separation grooves may be formed in the boundary portions between the arcuate surfaces 21a7.

While the multi-arc bearings of the above examples are so-called three-arc bearings, this should not construed restrictively. It is also possible to adopt a so-called four-arc bearing or five-arc bearing, or, further, a multi-arc bearing formed by six or more arcuate surfaces.

The dynamic pressure generating portions of the radial bearing portions R1 and R2 described above, such as the dynamic pressure grooves, the multi-arc surfaces, and stepped surfaces, can also be formed by utilizing sink generated through solidification of the resin portion 24 after the injection molding. In this case, by making the thickness of the resin portion 24 uneven in the circumferential direction, a difference in shrinkage amount (sink) generated in the circumferential direction results, thereby forming the dynamic pressure generating portions. For example, by performing insert molding with the outer peripheral surface of the shaft part 23a of the shaft blank 23 formed in a non-circular sectional configuration, and with the molding surface of the mold opposed thereto formed in a circular sectional configuration, the thickness of the resin portion 24 is made uneven in the circumferential direction, thereby attaining a difference in shrinkage amount.

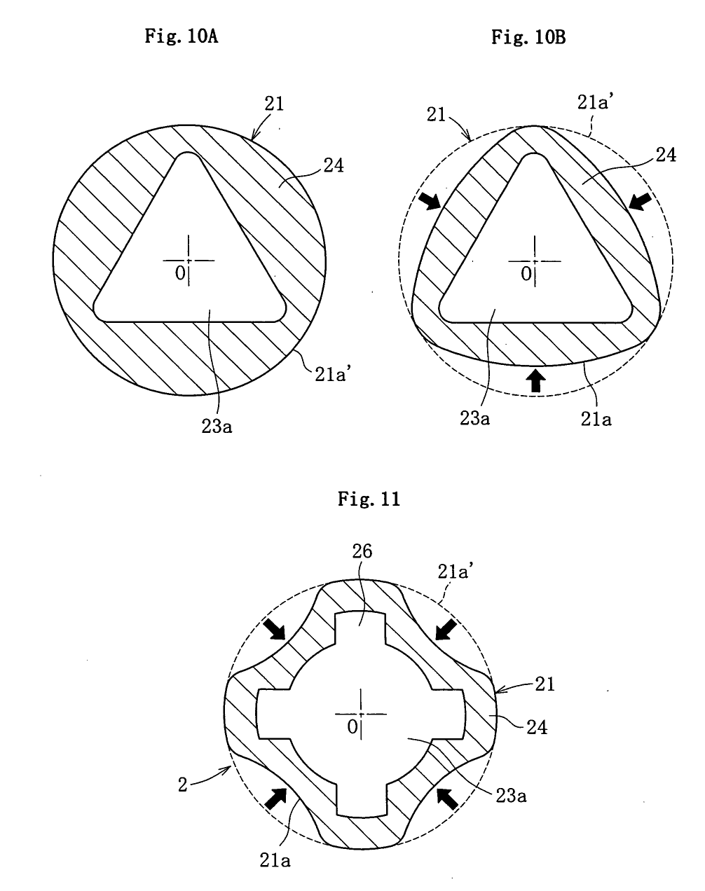

FIGS. 10A and 10B show an example in which the shaft part 23a constituting the shaft blank 23 is formed in a polygonal sectional configuration (a substantially triangular sectional configuration, in the example shown) and in which the molding surface 21a′ of the mold is formed in a circular sectional configuration (see FIG. 10A). In this case, as the resin portion 24 solidifies, the shrinkage in the directions of the arrows of FIG. 10B is generated more markedly in the thin-walled portion of the resin portion 24 than in the thick-walled portion of the resin portion 24, so it is possible to form a multi-arc surface on the outer peripheral surface 21a of the resin portion 24 as the dynamic pressure generating portion.

FIG. 11 shows another example in which radial protrusions 26 are provided at equal circumferential intervals on the outer peripheral surface of the shaft part 23a, and in which the molding surface 21a′ of the mold is formed in a circular sectional configuration. In this case also, as the resin portion 24 solidifies, it is possible to form a stepped surface as a dynamic pressure generating portion on the outer peripheral surface of the resin portion 24 through a difference in shrinkage amount due to the difference in the thickness of the resin portion 24.

While in the above-described embodiments dynamic pressure grooves arranged in a spiral fashion are provided as the dynamic pressure generating portions formed in the thrust bearing surfaces of the thrust bearing portions T, T1, and T2, it is also possible to form the thrust bearing portions T, T1 and T2 to be formed as so-called step bearings in which stepped surfaces are formed on the thrust bearing surfaces, so-called corrugated bearings (corrugated step type bearings), etc. (not shown).

The dynamic pressure generating portions of the thrust bearing portions T, T1, and T2 can also be formed in the same method as those for the examples shown in FIGS. 10 and 11. For example, when forming stepped surfaces as the dynamic pressure generating portions, insert molding is effected with the protruding part 23b of the shaft blank 23 formed in a stepped configuration, and with the molding surface of the mold opposed thereto as a flat surface without any asperities, whereby, due to the difference in shrinkage amount generated in the circumferential direction, it is possible to form stepped surfaces on the end surfaces of the resin portion 24.

While in the above embodiments a lubricating oil is adopted as the fluid to fill the interior of the fluid dynamic bearing device to generate a dynamic pressure in the radial bearing gap and the thrust bearing gaps, it is also possible to use other fluids capable of generating a dynamic pressure in each bearing gap, for example, a gas, such as air, a lubricant with fluidity such as a magnetic fluid, or a lubricating grease.

1-5. (canceled)

6. A fluid dynamic bearing device comprising:
a bearing member;
a shaft member equipped with a shaft portion to be inserted into an inner periphery of the bearing member;
a radial bearing portion supporting the shaft member in a radial direction by a dynamic pressure action of a fluid generated in a radial bearing gap; and
a thrust bearing portion supporting the shaft member in a thrust direction by a dynamic pressure action of the fluid generated in a thrust bearing gap,
wherein the shaft member is equipped with a shaft blank formed by integrating a shaft part constituting the shaft portion with a protruding part protruding radially outwards from the shaft part, and a resin portion covering at least one end surface of the protruding part and facing the thrust bearing gap.

7. A fluid dynamic bearing device according to claim 6, wherein the resin portion further covers an outer peripheral surface of the shaft part.

8. A fluid dynamic bearing device according to claim 6, wherein the resin portion has a dynamic pressure generating portion for generating a fluid dynamic pressure in at least one of the radial bearing gap and the thrust bearing gap.

9. A fluid dynamic bearing device according to claim 7, wherein the resin portion has a dynamic pressure generating portion for generating a fluid dynamic pressure in at least one of the radial bearing gap and the thrust bearing gap.

10. A fluid dynamic bearing device according to claim 8, wherein the dynamic pressure generating portion is formed through a difference in shrinkage amount of the resin portion.

11. A fluid dynamic bearing device according to claim 9, wherein the dynamic pressure generating portion is formed through a difference in shrinkage amount of the resin portion.

12. A motor comprising the fluid dynamic bearing device according to claim 6; a rotor magnet; and a stator coil.

13. A motor comprising the fluid dynamic bearing device according to claim 7; a rotor magnet; and a stator coil.

14. A motor comprising the fluid dynamic bearing device according to claim 8; a rotor magnet; and a stator coil.

15. A motor comprising the fluid dynamic bearing device according to claim 9; a rotor magnet; and a stator coil.

16. A motor comprising the fluid dynamic bearing device according to claim 10; a rotor magnet; and a stator coil.

17. A motor comprising the fluid dynamic bearing device according to claim 11; a rotor magnet; and a stator coil.
